(19) United States
(12) Patent Application Publication
(10) Pub. No.: US 2008/0011358 A1
(43) Pub. Date: Jan. 17, 2008

(54) Tapping assembly

(76) Inventors: Mark U. Brandt, Jefferson City, MO (US); Timothy L. Eggers, Washington, MO (US)

Correspondence Address: SHOOK, HARDY & BACON LLP;INTELLECTUAL PROPERTY DEPARTMENT, 2555 GRAND BLVD, KANSAS CITY, MO, 64108-2613, US

(21) Appl. No.: 11/487,819

(22) Filed: Jul. 17, 2006

(51) Int. Cl. F16L 55/18

(52) U.S. Cl. 137/318

(57) ABSTRACT

A tapping assembly implements a unitary saddle fitting design to enable the formation of a branch connection with a polymeric flowable material transmission line. The tapping assembly includes a unitary saddle fitting and a set of cutting elements operative to create openings in a structural wall of the transmission line and thereby form a fluid communication pathway from the transmission line through the saddle fitting and onto a service line connected with the tapping assembly.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

With the modernization of fluid and gas transmission networks, conduit mains for delivering to homes and businesses are increasingly more likely to be fabricated from polymeric materials, such as polyvinyl chloride (PVC) and other plastic-type materials. These utility mains are typically routed adjacent to or beneath streets in horizontally oriented trenches to convey pressurized natural gas or water from a main supply source to various locations where service line conduits tap into the main and draw gas or water therefrom. As a rule of thumb for supplying natural gas, service lines typically range from one-half inch to two inches in diameter depending on the level or service needed for the particular line, although service lines can also be much larger. Each service line may serve a single building structure or a group of buildings, such as a small office complex or a subdivision. Polymeric mains are advantageous due to the fact that service line connections with such mains are substantially easier than with a traditional cast iron conduit main. Additionally, polymeric materials are electrically insulative, thus providing a more stable medium in which to convey an explosive gas, and also are relatively easy to handle during subterranean installation and later repair.

Sidewall tapping tees and full flow tees have been developed to create a junction or branch connection between a polymeric main and a service line. Sidewall tapping tees are mounted on the exterior surface of the main, while full flow tees are actually place in-line where a section of the main is removed. In a conventional design, a sidewall tapping tee includes a base for mounting with a cylindrical main in a circumscribing fashion, a riser portion extending upwardly from the base for housing a threaded cutting member and flow passageway, and an arm extending arm from the riser portion to provide a branch connection point for a service line extending to a building. The cutter is typically threadingly received within the riser portion and has a top face with a recess for accepting a hex wrench or other tool, and a lower annular cutting edge. By using the tool to drive rotation of the cutter, the cutting edge moves downwardly through the flow passageway and eventually through an opening in the base to engage with and cut in a radially advancing direction through a cylindrical wall of the main on which the tapping tee is mounted. The cutter is retracted back through the base opening and up through the flow passageway a sufficient amount as to expose a service passageway through the laterally extending arm. A flow path is thereby formed to allow gas or water in the main to be conveyed through the base opening and through the flow passageway to the service passageway and onto a service line secured with the laterally extending arm and extending perpendicularly to the main. One advantage of a sidewall tapping tee when tapping into a gas transmission main is that the flow of gas through the main does not have to be shut off during the tee installation process. With a full flow tee, the gas or water main must actually be sectioned or cut through to remove a portion of the main that is replaced by the tee, which requires, in some cases, an interruption of service flow to customers along the main. The full flow tee includes outlets aligned longitudinally with the main as well as a perpendicularly extending service arm for connection with a branch line.

Although sidewall tapping tees and full flow tees provide a means for creating a junction for a polymeric gas or water main, there are a number of drawbacks with conventional designs and installation processes for each type of tee. For instance, with sidewall taping tees of the aforementioned design, because the lateral arm must extend perpendicularly from the riser portion, and the lateral arm extends horizontally to couple with a horizontally-oriented buried branch line, the riser portion necessarily extends vertically from the main to which the taping tee is mounted. This is problematic because it significantly increases the risk of damage to the taping tee if future excavation work is done in the vicinity of the main conduit. Contractors and other third party workers can typically find out how far down below the ground surface a gas or water main is buried from a utility company, but it is difficult to know at what particular point along a section of a subterranean conduit main a taping tee is attached and how far above the main the tee rises vertically. For instance, a worker will often begin to unearth a section of a main with earth moving equipment to within a few inches of a depth at which the conduit is reported to be buried, and then fully unearth the main using hand shovels or other tools to avoid damaging the main. However, if the worker does not take into account that a sidewall tapping tee provides a 6 inch or more rise above the buried main, there is a high probability that the tee could be damaged during the excavation process. Traditional sidewall tapping tee designs are also limited in the size or diameter of the branch connection that can be made based on the diameter of the main conduit. More specifically, if the ratio of the diameter of the cutter (and thus the opening cut radially into the main) to the overall main diameter is sufficiently large, the structural integrity of the main could be compromised during operation. It may be desired, however, to create a relatively large opening in the main to achieve a flow through the branch connection sufficient to meet the needs of the customers along the service line. As one example, it can difficult or even impossible to form a 4 or 6 inch diameter opening for a branch connection with only a 6 inch outside diameter main. Full flow tees, in contrast, provide a wider range of options for branch connection openings from mains of various sizes. Still though, full flow tees require depressurization of a section of a main where the full flow tee is to be installed. Even if service flow interruption to other customers can be avoided, such as in the case of a pressurization feed in the main conduit from both directions, the equipment and labor necessary to squeeze off a main, and to actually cut out and remove a section of the main for installation of the tee, can be substantial. Therefore, existing devices have failed to provide a reliable and simple solution for creating branch connections off a transmission main where the future risk in damaging the junction formed remains low.

### SUMMARY OF THE INVENTION

A tapping assembly of the present invention enables the formation of a branch connection with a polymeric flowable material transmission line, such as a gas or water conduit main. The tapping assembly includes a unitary saddle fitting and a set of cutting elements operative to create openings in a structural wall of the transmission line and thereby form a fluid communication pathway from the transmission line through the saddle fitting and onto a service line connected with the tapping assembly. The unitary saddle fitting has a base portion formed with a set of intake ports, as well as a manifold extending outwardly from the base portion which is characterized by a primary passageway and a set of secondary passageways. The primary passageway extends from the set of intake ports to a branch outlet and each secondary passageway is aligned with one of the intake ports and extends from the primary passageway to a tapping outlet. Additionally, each secondary passageway has a threaded portion for receiving matching threads on a cutting element to enable each cutting element to be driven towards a cutting surface of the transmission line.

In use, the tapping assembly is first coupled to the structural wall of the transmission line by fitting the base portion onto the wall in at least a partially circumscribing fashion. Each cutting element is rotationally driven by a tool engaged therewith through the respective secondary passageway and through the respective intake port to contact the structural wall and cut therethrough to form a resulting cutout in the transmission line wall. The cutting element is then retracted through rotation in the opposite direction to move out of the cutout in the transmission line wall and the respective intake port to reveal the fluid communication pathway through the manifold of the saddle fitting. Sealing caps may be secured onto tapping stems of the manifold to seal off each tapping outlet after the cutting process is completed so that the flow pathway through the tapping assembly extends from the intake ports to the branch outlet for delivering the flowable material to a service line coupled to the assembly.

The tapping assembly design of the present invention, including a unitary fitting having multiple secondary passageways in which cutting elements travel, allows for the use of smaller diameter cutting elements in creating a given total flow path to a service line from the transmission line. With a traditional single cutter sidewall tapping tee, sufficient fluid flow through the tee can sometimes only be obtained when the diameter of the cutting element approaches the diameter of the structural wall of the transmission line, which can compromise the structural integrity of the transmission line. Additionally, by positioning the tapping outlets and the branch outlet generally in the same plane, the tapping assembly provides a low-profile design extending substantially laterally from a horizontally extending transmission line. This low-profile enables the assembly to minimize the structure that rises above the transmission line, reducing the chance that equipment used to unearth the line from above would damage the assembly.

Additional advantages and features of the invention will be set forth in part in a description which follows, and in part will become apparent to those skilled in the art upon examination of the following, or may be learned by practice of the invention.

### BRIEF DESCRIPTION OF THE SEVERAL VIEWS OF THE DRAWINGS

In the accompanying drawings, which form a part of the specification and are to be read in conjunction therewith and in which like reference numerals are employed to indicate like parts in the various views:

FIG. 1 is a top plan view of one embodiment of a tapping assembly of the present invention installed on a section of a transmission line;

FIG. 2 is partially sectioned view of the tapping assembly of FIG. 1, illustrating the flowpath from the transmission line through a manifold of the tapping assembly;

FIG. 3 is an exploded view of the tapping assembly, partially in section, taken along line section line 4-4 of FIG. 1;

FIG. 4 is a sectional view of the tapping assembly taken along line 4-4 of FIG. 1, depicting the cutting element in a position for engagement with a wall of the transmission line; and

FIG. 5 is a side elevational view of the tapping assembly coupled onto a section of the transmission line in a subterranean application.

### DETAILED DESCRIPTION OF THE INVENTION

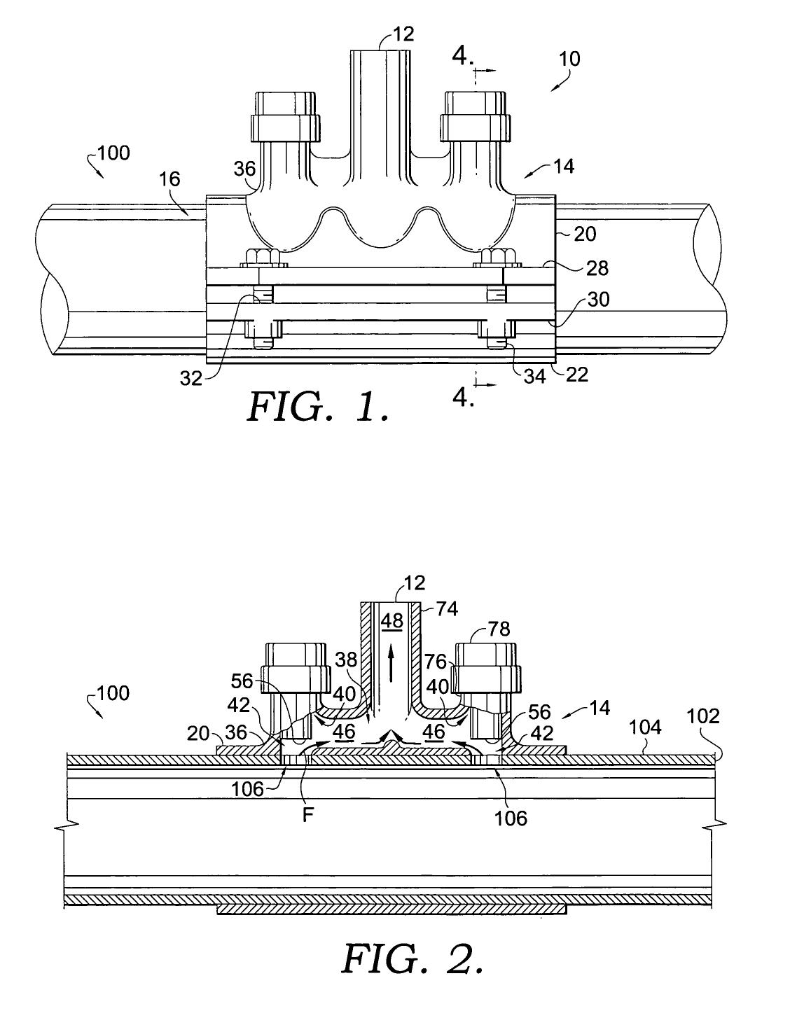

Referring now in more detail to the drawing figures, and initially to FIG. 1, a tapping assembly of the present invention designated by reference numeral 10 is shown in use on a transmission line 100, such as a natural gas or water conduit main. The tapping assembly 10 provides a junction between the transmission line 100 and a service or branch line (not shown) connected with a branch outlet 12 of the tapping assembly 10, as can be seen with further clarity in FIG. 2. The tapping assembly generally includes a unitary saddle fitting 14 and a coupling device 16 for coupling or initially securing the saddle fitting 14 onto a section of a structural wall 102 of the transmission line 100 prior to engaging in a tapping sequence on the transmission line 100.

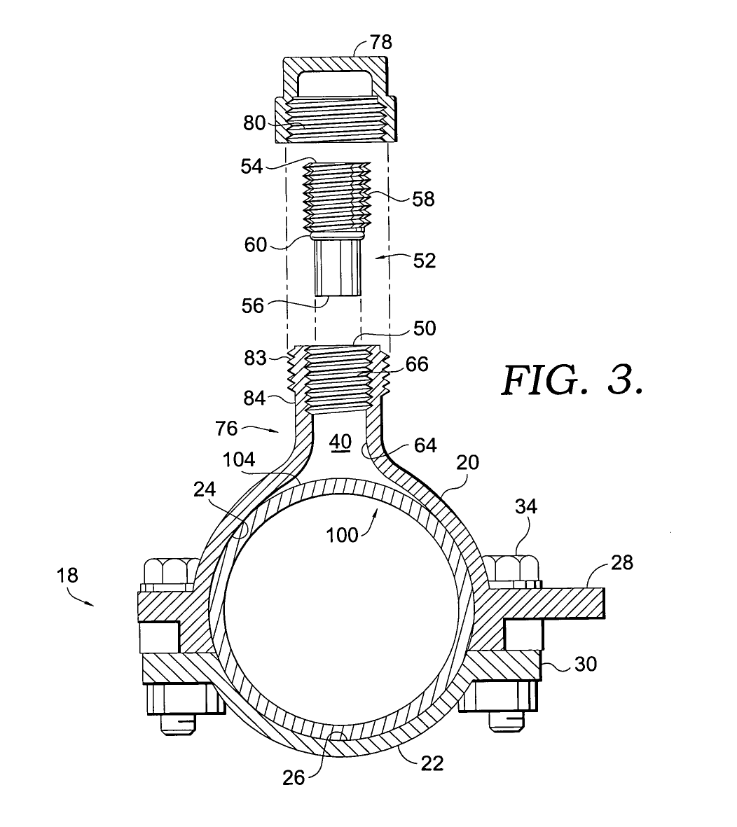

For instance, as illustrated in FIG. 1, and with additional reference to FIG. 3, one embodiment of the tapping assembly 10 includes an adjustable split collar 18 serving as the coupling device 16. The collar 18 is formed by a base 20 of the saddle fitting 14 and a corresponding opposed free collar member 22. Both the saddle fitting base 20 and the free collar member 22 have generally cylindrically-shaped mating surfaces 24 and 26, respectively, to achieve circumferential mating with an outside surface 104 of the structural wall 102 of the transmission line 100. The saddle fitting base 20 and the free collar member 22 also each have outwardly extending mounting flanges 28 and 30, respectively, through which apertures 32 extend for receiving a set of fasteners 34. With the saddle fitting 14 and the free collar member 22 separated, the base 20 of the saddle fitting 14 and the free collar member 22 are extended over a chosen section of the transmission line structural wall 102 and secured together onto the outside surface 104 of the wall 102 with the fasteners 34. More specifically, the apertures 32 of the mounting flanges 28 and 30 are aligned so that the fasteners 34 can couple the flanges 28 and 30, and thus the saddle fitting base 20 and the free collar member 22, together on the transmission line 100. In an alternative arrangement, the coupling device 16 may take the form of the saddle fitting base 20 and adjustable strapping material (not shown) circumscribing the transmission line 100 and extending over the saddle fitting base 20 to secure the saddle fitting 14 to the line 100 without the use of a free collar member 22. Those of skill in the art will appreciate that other means may be implemented to provide initial coupling of the tapping assembly 10 with a section of the transmission line 100.

With continued reference to FIGS. 2 and 3, the unitary saddle fitting 14 is formed with a manifold 36 extending outwardly from the base 20 to provide a flow pathway leading from the transmission line 100 to a connected service line. The manifold 36 includes a primary passageway 38 and set of secondary passageways 40 disposed on opposed lateral sides of the primary passageway 38. The primary passageway 38 extends from a set of intake ports 42 formed through the saddle fitting base 20 to the branch outlet 12 where a service line can connect with the tapping assembly 10. More specifically, the primary passageway 38 is defined by opposed lateral conduit sections 46 that merge to form a main conduit section 48 moving downstream towards the branch outlet 12. Each secondary passageway 40 is generally cylindrically shaped and axially aligned with one of the intake ports 42, extending from one of the lateral conduit sections 46 of the primary passageway 38 to a tapping outlet 50. The branch outlet 12 and each tapping outlet 50 are preferably bisected in the same plane, allowing the manifold 36 of the saddle fitting 14 to maintain a low-profile that extends essentially in a single lateral direction to connect with a horizontally extending service line transversely arranged with respect to the transmission line 100.

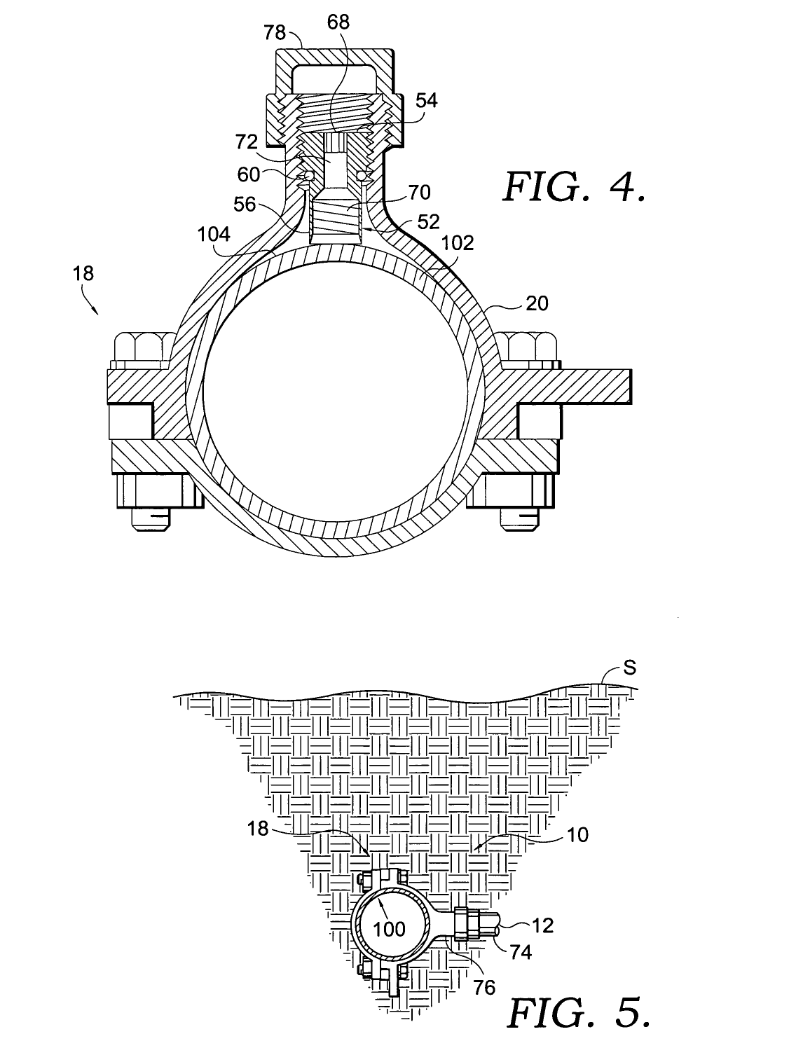

Each secondary passageway 40 is configured for receiving therein a cutting element 52 that may be rotationally driven towards the respective intake port 42 to eventually reach the transmission line structural wall 102 when the tapping assembly 10 is coupled to the transmission line 100. In this way, the secondary passageways 40 largely serve to guide the movement of cutting elements 52 towards the respective intake ports 42 to generate radially-extending cutouts 106 in the structural wall 102 of the transmission line 100, while the primary passageway 38 functions as the continuous flow pathway for flowable material (i.e., natural gas, water, etc.) from the transmission line 100 through the manifold 36 to an attachment point for a service line at the branch outlet 12. Specifically, with reference to FIG. 3 and additional reference to FIG. 4, each cutting element 52 has a tool engaging first end 54, a second opposed end formed as an annular working blade 56, and threaded body portion 58 therebetween. Additionally, the cutting elements 52 may each have a sealing washer 60, or o-ring, below the threaded body portion 58 to seal off any pathway between the cutting element 52 and the inner wall 64 forming the secondary passageway 40. An internal threaded section 66 of the secondary passageway 40 has matching threads with the cutting element body portion 58 to support the rotational movement of the cutting element 52. The tool engaging first end 54 of the cutting element 52 includes a shaped bore 68 for receiving therein any chosen tool configuration. For instance, in the case of the bore 68 having a hexagonal shape, a hex wrench (or other appropriately shaped tool) can mate and engage with the bore 68 to rotate the cutting element 52 according to the guidance of the threaded body portion 58 interfacing with the threaded section 66 of the secondary passageway 40.

As seen in FIG. 4, rotation of the cutting element 52 a sufficient amount in a first direction drives the working blade 56 through the respective intake port 42 to engage with the transmission line structural wall 102. Continued rotation in the same direction forces the working blade 56 through the structural wall 102 at an annular profile, thereby forming the circular cutout 106 in the wall 102, as illustrated in FIG. 2. Thereafter, rotation of the cutting element 52 in an opposed, second direction retracts the working blade 56 through the intake port 42 and back further into the secondary passageway 40. The flow of gas or water from the transmission line 100 through the cutout 106 and into the manifold 36 of the tapping assembly 10, represented by arrows F in FIG. 2, becomes less inhibited the greater the working blade 56 is retracted out of the respective lateral conduit section 46. A plug (not shown) of the structural wall cutout 106 is held by a series of grooves 70 within the annular working blade 56 to inhibit the flow of gas or water from the transmission line 100 through a central bore 72 of the cutting element 52 and up the secondary passageway 40.

The saddle fitting 14 is preferably shaped around the manifold 36 such that a branch stem 74 establishes the main conduit section 48 of the primary passageway 38 and a set of tapping stems 76 each establishing one of the secondary passageways 40. In this way, the branch stem 74 terminates at the branch outlet 12 and each tapping stem 76 terminates at one of the tapping outlets 50. A sealing cap 78 having an internally threaded collar 80 is received by mating threads 82 on the outer surface 84 of each of the tapping stems 76. The sealing cap 78 serves to seal off the tapping outlets 50 of the set of secondary passageways 40 once the tapping sequence with the cutting elements 52 is complete, ensuring that flow through the manifold 36 is directed from the intake ports 42 through the primary passageway 38 and out through the branch outlet 12. In an alternative arrangement, the collar 80 of each sealing cap 78 may have external threads for engaging with the internal threaded section 66 of one of the secondary passageways 40 above the respective cutting element 52, such that the collar 80 is received within the tapping stem 76.

After the tapping assembly 10 is initially secured onto a section of the transmission line 100 by the split collar 18, the region surrounding each intake port 42 on the mating surface 24 of the saddle fitting base 20 needs to be sealed with the outside surface 104 of the transmission line structural wall 102. This ensures that flow leaving one of the cutouts 106 in the structural wall 102 moves directly into the respective intake port 42 and into the manifold 36 without leaking through any gap between the mating surface 24 of the saddle fitting base 20 and the outside surface 104 of the structural wall 102. Accordingly, sealing of the mating surface 24 with the outside surface 104 of the transmission line structural wall 102 may be made by various means, such as by the use of a solvent, cement, glues (e.g., PVC glue for a transmission line 100 and saddle fitting 14 formed of PVC), or other arrangements. As one example, a o-ring may be placed within an annular recess (not shown) in the mating surface 24 surrounding each intake port 42 to seal against the outside surface 104 of the structural wall 102. In still another example, electrofusion may be utilized to seal the mating surface 24 with the structural wall outside surface 104. With electrofusion, a heating element (not shown) formed by conductive pathway on the mating surface 24 surrounding each intake port 42 causes melt fusion between the surfaces 24 and 104 in the region surrounding the intake port 42.

By configuring the primary passageway 38 with opposed lateral conduit sections 46 extending from multiple intake ports 42 to the main conduit section 48, a flow path is created that avoids significant pressure drops between the cutouts 106 in the transmission line 100 and the branch outlet 12 where a service line connects. As one exemplary configuration, a transmission line 100 having a 2 inch outer diameter may be tapped by the tapping assembly 10 including a pair of cutting elements 52 each having a working blade 56 sized to form a 1 and ⅛ inch cutout 106 in the transmission line 100. Additionally, the intake ports 42 and the lateral conduit sections 46 of the primary passageway 38 are sized to maintain a diameter at least as large as the cutout 106 diameter, in this case a 1 and ⅛ inch diameter, while the main conduit section 48 has a 2 inch diameter to match the internal diameter of a service line to be coupled with the branch outlet 12. This configuration serves to minimize pressure drop through the manifold 36 while providing the desired amount of flow to the service line. Those of skill in the art will appreciate, however, that other dimensions may be selected in order to maintain adequate flow through the manifold 36 based on a given diameter of a selected transmission line 100. In any case, the tapping assembly 10 provides significantly improved flow for a sidewall tapping tee where the diameter of the service line to be connection approaches the diameter of the transmission line.

With a traditional tapping tee, forming a cutout 106 with a diameter approaching the size of the outer diameter of the transmission line 100, if even possible, would seriously affect the structural integrity of the transmission line 100 and any bond formed between the mating surface 24 and the outside surface 104 of the structural wall 102. The tapping tee 10 of the present invention avoids this problem by providing multiple, smaller diameter cutouts 106 and a manifold 36 configured to provide flow to the branch outlet 12 and connected service line that is equivalent to flow that would be realized through one larger cutout 106 if the transmission line 100 had been sized adequately to support such a large cutout. Furthermore, by utilizing a saddle fitting 14 that is unitary in nature, the tapping assembly 10 functioning as a multiple cutter tapping tee can be initially coupled to a transmission line 100 (i.e., prior to sealing or fusing the base 20 with the outside surface 104) in essentially one step. In one embodiment, the unitary saddle fitting 14 and free collar member 22 are each formed by molding a polymeric material, such as one or more plastics and the like. The cutting elements 52 may be formed from various materials having a hardness greater than the hardness of the polymeric transmission line 100. For instance, the cutting elements 52 may be formed from solid brass or other metals. It should also be understood that additional secondary passageways 40 and corresponding cutting elements 52 and intake ports 42 may be provided for each primary passageway 38 and branch outlet 12 in the saddle fitting 14.

Turning to FIG. 5, the low-profile mounting of the tapping assembly 10 on a subterranean transmission line 100 section is depicted. In this configuration, the manifold 36 extends generally within a plane aligned with the longitudinal axis of the transmission line 100. Thus, when the transmission line 100 is installed horizontally, the branch stem 74 and tapping stems 76 of the tapping housing 14 are also horizontally oriented and transverse to the longitudinal dimension of the transmission line 100. With traditional sidewall taping tees, the riser portion housing the cutting element extends well above the top of the transmission line 100 towards the surface S, increasing the likelihood that the taping tee will be damaged by excavation activities. The tapping assembly 10 of the present invention merely has a portion of the split collar 18 (or other coupling device 16) disposed above the transmission line 100 when installed, decreasing the likelihood that the buried tapping assembly 10 would be damaged during excavation.

As can be understood, the tapping assembly 10 of the present invention provides a self-contained unit for creating an adequately sized flow junction between a polymeric transmission line 100 and a service line. The tapping assembly 10 also has a decreased likelihood of being damaged by excavation activities in a subterranean installation as compared to traditional sidewall taping tees.

Furthermore, since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

What is claimed is:

1. A tapping assembly for forming a branch connection with a primary polymeric flowable material transmission line, comprising:
a unitary saddle fitting including:
a base portion presenting an interfacing surface shaped for circumferential mating with an outside surface of the transmission line and a set of intake ports spaced from one another and formed in the interfacing surface;
a manifold extending outwardly from the base portion and formed with a primary passageway and a set of secondary passageways, the primary passageway extending from the set of intake ports to a branch outlet and each secondary passageway being axially aligned with one of the intake ports and extending from the primary passageway to a tapping outlet spaced from the branch outlet; and
a set of cutting elements, each cutting element having a first end formed with a tool engaging portion, a second end formed with a working blade, and a body portion adapted for being threadingly received within one secondary passageway of the set of secondary passageways;
wherein movement of the cutting element in a first direction of rotation within the respective secondary passageway initiated by a tool acting on the tool engaging portion causes the working blade to be driven towards the interfacing surface for advancing the working blade through a respective one of the intake ports, and subsequent movement of the cutting element in a second direction of rotation causes the working blade to be retracted from the respective one of the intake ports.

2. The tapping assembly of claim 1, further comprising means for mounting the unitary saddle fitting onto the transmission line.

3. The tapping assembly of claim 2, wherein the means for mounting includes a split collar assembly formed by the combination of the base portion of the unitary saddle fitting and an opposed clamp member removably coupled with the unitary saddle fitting base portion to mate with and circumscribe the outside surface of the transmission line.

4. The tapping assembly of claim 1, further comprising a set of sealing caps adapted for being threadingly received on the manifold to seal off each tapping outlet of the set of secondary passageways.

5. The tapping assembly of claim 1, wherein the manifold is formed with a branch stem defining the branch outlet and a set of tapping stems each defining one of the tapping outlets, at least one of the tapping stems being disposed on an opposite lateral side of the branch outlet from another at least one of the tapping stems.

6. The tapping assembly of claim 1, wherein the branch outlet and each of the tapping outlets are bisected in the same plane.

7. A transmission line tapping housing, comprising:
a unitary saddle fitting including a base portion formed with a set of intake ports spaced from one another and a manifold extending outwardly from the base portion, the manifold characterized by a primary passageway and a set of secondary passageways, the primary passageway extending from the set of intake ports of the base portion to a branch outlet and each secondary passageway being axially aligned with one of the intake ports and extending from the primary passageway to a tapping outlet spaced from the branch outlet, each secondary passageway having a threaded portion for receiving a matching threaded cutting element;
wherein the base portion is adapted for coupling to a transmission line such that upon coupling thereto, cutting elements driven though the secondary passageways and the intake ports engage with a structural wall of the transmission line to form cutouts in the structural wall, each cutout establishing a fluid communication pathway from the transmission line through the manifold of the saddle fitting to the branch outlet.

8. The tapping housing of claim 7, wherein the base portion is shaped for circumferential mating with the structural wall of the transmission line.

9. The tapping housing of claim 7, wherein the base portion of the unitary saddle fitting is adapted for coupling to the transmission line by a split collar assembly formed by the combination of the base portion and an opposed clamp member removably coupled with the base portion to mate with and circumscribe the outside surface of the transmission line.

10. The tapping housing of claim 7, further comprising a set of sealing caps adapted for being threadingly received on the manifold to seal off each tapping outlet of the set of secondary passageways.

11. The tapping housing of claim 7, wherein the manifold is formed with a branch stem defining the branch outlet and a set of tapping stems each defining one of the tapping outlets, at least one of the tapping stems being disposed on an opposite lateral side of the branch outlet from another at least one of the tapping stems.

12. The tapping housing of claim 7, wherein the branch outlet and each of the tapping outlets are bisected in the same plane.

13. A method of forming a branch connection with a primary polymeric flowable material transmission line, comprising:
providing a unitary saddle fitting including a base portion formed with a set of intake ports spaced from one another and a manifold extending outwardly from the base portion, the manifold characterized by a primary passageway and a set of secondary passageways, the primary passageway extending from the set of intake ports of the base portion to a branch outlet and each secondary passageway being axially aligned with one of the intake ports and extending from the primary passageway to a tapping outlet spaced from the branch outlet, wherein each secondary passageway has an internal threaded portion;
providing a set of externally threaded cutting elements, each cutting element adapted to be threadingly received within one secondary passageway of the set of secondary passageways;
coupling the base portion of the unitary saddle fitting to a structural wall of the transmission line;
driving each cutting element through the respective secondary passageway of the set of secondary passageways, through the respective intake port of the set of intake ports axially aligned with the respective secondary passageway, and through the structural wall of the transmission line to form a cutout aligned with each intake port;
retracting each cutting element through the respective cutout in the transmission line structural wall and the respective intake port to establish a fluid communication pathway from the transmission line through each cutout and extending through the manifold of the saddle fitting to the branch outlet.

14. The method of claim 13, further comprising:
providing a set of sealing caps adapted for being threadingly received on the manifold; and
threadingly mounting each sealing cap over one of the tapping outlets to seal off each tapping outlet of the set of secondary passageways.

15. The method of claim 13, wherein the branch outlet and each of the tapping outlets are bisected in the same plane.
